(19) United States
(12) Patent Application Publication
(10) Pub. No.: US 2009/0293714 A1
(43) Pub. Date: Dec. 3, 2009

(54) Continuously Blockable Locking Device

(75) Inventors: Frank Born, Dienethal (DE); Frank Doffing, Kastellaun (DE); Thomas Klar, Bendorf (DE); Rolf Mintgen, Thuer (DE); Gerd Mülhöfer, Laubach (DE); Timo Schumacher, Weißenthum (DE)

Correspondence Address: COHEN, PONTANI, LIEBERMAN & PAVANE LLP, 551 FIFTH AVENUE, SUITE 1210, NEW YORK, NY, 10176, US

(73) Assignee: Stabilus GmbH, Koblenz (DE)

(21) Appl. No.: 12/473,991

(22) Filed: May 28, 2009

(30) Foreign Application Priority Data
May 28, 2008 (DE) 10 2008 025 562.9

(51) Int. Cl. F15B 15/20

(52) U.S. Cl. 92/8

(57) ABSTRACT

A continuously blockable locking device with a cylindrical housing forming a work chamber, a closed first end and a second end located opposite from the closed end, a piston rod which is guided out of the housing in a sealed manner through the second end so as to be arranged coaxial to the center longitudinal axis by means of a guiding and sealing device, a piston which is arranged at the end of the piston rod situated in the housing and which divides the work chamber into a first work space, through which the piston rod extends, and a second work space, and a housing which is connected to, or can be connected to, the housing and which forms a valve chamber, a first valve assembly and a second valve assembly being arranged therein. The work chamber is always completely filled with a liquid medium and the valve chamber is at least partially filled with a liquid medium.

### BACKGROUND OF THE INVENTION

1. Field of the Invention

The invention is directed to a continuously blockable locking device with a cylindrical housing forming a work chamber, a closed first end and a second end located opposite from the closed end, a piston rod which is guided out of the housing in a sealed manner through the second end so as to be arranged coaxial to the center longitudinal axis by means of a guiding and sealing device, a piston which is arranged at the end of the piston rod situated in the housing and which divides the work chamber into a first work space, through which the piston rod extends, and a second work space, and a housing forming a valve chamber connected, the housing forming the work chamber, a first valve assembly and a second valve assembly being arranged therein.

2. Description of the Related Art

A locking device of the type mentioned above is known from DE 44 04 467 C2, wherein the valve assemblies are arranged in overflow channels and outlet channels and are connected to an overflow reservoir by an overflow channel, which requires a relatively large installation space.

### SUMMARY OF THE INVENTION

It is an object of the invention to provide an economical, continuously blockable locking device with a compact structural shape.

This object is met in that the work chamber is always completely filled with a liquid medium and the valve chamber is at least partially filled with a liquid medium.

In a further embodiment, a first connection channel is constructed near a first end wall of the valve chamber, and a second connection channel is constructed near a second end wall of the valve chamber, and the first connection channel and second connection channel connect the work chamber to the valve chamber.

In a particular construction, the valve chamber is filled mostly with the liquid medium and is filled to a small extent with a gas under pressure.

In an advantageous manner, the liquid medium is a hydraulic oil and the gas is nitrogen.

In an advantageous embodiment of the invention, a first valve assembly is arranged in the valve chamber near the first end wall, and a second valve assembly is arranged in the valve chamber near the second end wall.

Further, the two valve assemblies are arranged at a distance from one another and a connection space is formed between the two valve assemblies.

In another embodiment, the first valve assembly comprises a force-loaded check valve whose closing member opens in the direction of flow from the first end wall to the connection space against the force of a helical compression spring during an outward movement of the piston rod and the resulting increase in pressure in the first work space, wherein the oil displaced by the piston flows into the connection space and then into the second work space via an unloaded check valve of the second valve assembly.

The second valve assembly likewise comprises a force-loaded check valve whose closing member opens in the direction of flow from the second end wall to the connection space against the force of a helical compression spring during an inward movement of the piston rod and the resulting increase in pressure in the second work space, wherein the oil displaced by the piston flows into the connection space and then into the first work space via an unloaded check valve of the first valve assembly.

The housing has a closable opening at its upper side so that the oil and gas can be introduced or removed in a simple manner.

In an advantageous further embodiment of the invention, the force-loaded check valves and the unloaded check valves of the first valve assembly and of the second valve assembly are arranged in a material block, and every material block can be constructed as part of the housing.

In a particular embodiment, the valve chamber has a circular or at least partially oval cross-sectional shape.

The work chamber preferably has a longer extension in axial direction than the valve chamber.

In an advantageous further embodiment of the invention, a damping cup is arranged in the extension of the work chamber, and a damping sleeve which is arranged at the piston penetrates into this damping cup when the piston rod moves outward.

In a further embodiment of the invention, a through-opening extends from the connection space and connects the valve chamber to another volume compensation chamber which is arranged above the valve chamber and which is filled with oil and a gas.

In a further embodiment, the housing of the volume compensation chamber has a closable opening at its upper side through which the oil or the gas can be introduced or removed.

In an advantageous embodiment of the invention, the two valve assemblies and their respective force-loaded and unloaded check valves are arranged in a tubular valve receiving body which can be inserted into the valve chamber.

In another embodiment, the valve receiving body has, at its ends, a closure wall which faces the first end wall and a closure wall which faces the second end wall, a first annular chamber being located between the first end wall and the closure wall, and a second annular chamber being located between the second end wall and the closure wall.

Further, the force-loaded check valve and the unloaded check valve are advantageously arranged in the closure wall, and the force-loaded check valve and the unloaded check valve are arranged in the closure wall.

In another embodiment, a sealing device is provided at the respective ends of the valve receiving body.

In a preferred embodiment of the invention, sealing devices form the unloaded check valves.

In another embodiment, the housing is arranged at a fastening bracket.

The fastening bracket advantageously has a substantially-U-shaped web whose first end is connected by a fastening pin to a knuckle eye arranged at the second end wall.

In an advantageous further embodiment of the invention, a flange is formed at the second end of the web located opposite from the first end, and the flange has two projections, each with an internal thread, for fastening the bracket to a swivelable structural component part, in particular a vehicle door.

In a further embodiment, the flange is connected to a plate in which a cutout is provided through which the piston rod extends, and bellows which are connected to the piston rod near a connection element formed as a ball socket can be inserted into the cutout.

Alternatively, the fastening bracket is arranged at the area of the housing of the work chamber extending past the housing of the valve chamber.

In a further embodiment of the invention, the housing is fastened by two angled plates to the area of the housing of the work chamber extending past the housing of the valve chamber.

In an advantageous embodiment, the connection channels are formed by a tubular extension which extends radially from the housing of the valve chamber and which has a radially circumferential groove in which a sealing ring is inserted and by a tubular extension which extends radially from the housing of the work chamber and which is slid over the first extension mentioned above.

Alternatively, at least two catch arms extend from the housing of the valve chamber, each catch arm having a hook which engages in such a way behind a catch projection formed laterally at the housing of the work chamber that the first connection channel and second connection channel, respectively, connect the work chamber and the valve chamber or the housing of the work chamber and the housing of the valve chamber to one another.

In another embodiment of the invention, the housing of the work chamber and the housing of the valve chamber are held together by a clamp comprising two catch arms, each of which again has a hook which engages behind the catch projections formed laterally at the housing of the work chamber.

In an alternative embodiment, the housing of the work chamber and the housing of the valve chamber are surrounded by a belt-like holding element which holds together the two housings.

The two radial extensions which are joined together can also be welded together at least in some areas in order to hold the two housings together.

Alternatively, the extension formed at the housing of the valve chamber can have another groove in which a snap ring is inserted which is completely pressed into the groove when joining and which snaps into the groove which is formed inside the extension arranged at the housing of the work chamber when a defined position is reached.

In order to make possible a compact construction with valve assemblies that are arranged closely adjacent to one another, first and second valve assemblies are arranged parallel to one another and perpendicular to the cylindrical work chamber in another embodiment form according to the invention.

In a further embodiment, the connection space which directly connects the first and second valve assemblies to one another adjoins the end of the upwardly directed side of the two valve assemblies which is remote of the work chamber.

According to one embodiment of the invention, the valve chamber can be divided at least partially into a first partial chamber and a second partial chamber by means of a dividing wall, the first valve assembly being accommodated in the first partial chamber and the second valve assembly being accommodated in the second partial chamber, and the two partial chambers are connected to one another by the connection space.

In order to provide any desired length for the work chamber and, consequently, any lift length regardless of the structural size of the valve chamber, the connection channel is formed parallel to the work chamber and forms a fluidic connection between the second work space and the second valve assembly.

In another advantageous embodiment, at least one flow channel is provided in the cover closing the work chamber and/or a connection slot is provided between the second work space and the second connection channel which is guided parallel to the latter.

In so doing, the first connection channel connects the first work space to the valve chamber by a receiving chamber.

It is particularly advantageous for a simple construction when a cover is arranged on the valve chamber, which cover closes the valve chamber to seal it relative to the outer environment and holds the first valve assembly and second valve assembly in their position, wherein the cover has, for every valve assembly, a holding web around which work medium flows and which brings the valve assemblies into contact with the wall of the work chamber.

In order to make the locking device even more versatile, an electrically controllable valve unit or a cover can be arranged at the receiving chamber.

Further, according to one embodiment of the invention, a sensor device is arranged at the pivot point of the housing at the fastening bracket, and the angle and/or angular velocity can be determined by means of this sensor device.

In an alternative construction according to one embodiment of the invention, the dividing wall in the valve chamber is formed by two dividing walls forming a receiving space therebetween.

According to one embodiment of the invention, an electrically controllable valve unit or a filling body can be inserted into the receiving space. The filling body keeps two openings in the dividing walls closed, and the openings can be opened or closed by the valve unit.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

Embodiment examples of the invention are shown in the drawings and are described more fully in the following.

FIGS. 1a-1b are a longitudinal section and a cross section of a first embodiment form of a continuously blockable locking device according to the invention;

FIGS. 2a-2b are a door arresting device according to the invention;

FIG. 3 is a door arresting device according to the invention;

FIGS. 4a-4b is a door arresting device;

FIGS. 5a-5b is a door arresting device;

FIGS. 6a-6b is a door arresting device;

FIG. 7 is a device for the locking device according to the invention;

FIG. 8 is a fastening device;

FIG. 9 is a form of the fastening device;

FIG. 10 is a possibility for connecting the work chamber and valve chamber;

FIG. 11 is a possibility for connecting the work chamber and valve chamber;

FIG. 12 is a possibility for connecting the work chamber and valve chamber;

FIG. 13 is a possibility for connecting the work chamber and valve chamber;

FIG. 14 is a possibility for connecting the work chamber and valve chamber;

FIG. 15 is a for connecting the work chamber and valve chamber;

FIG. 16 is a door arresting device according to the invention;

FIG. 17 is another locking device according to the invention;

FIG. 18 is a door arresting device according to the invention; and

FIG. 19 is a locking device according to the invention.

### DETAILED DESCRIPTION OF THE PRESENTLY PREFERRED EMBODIMENTS

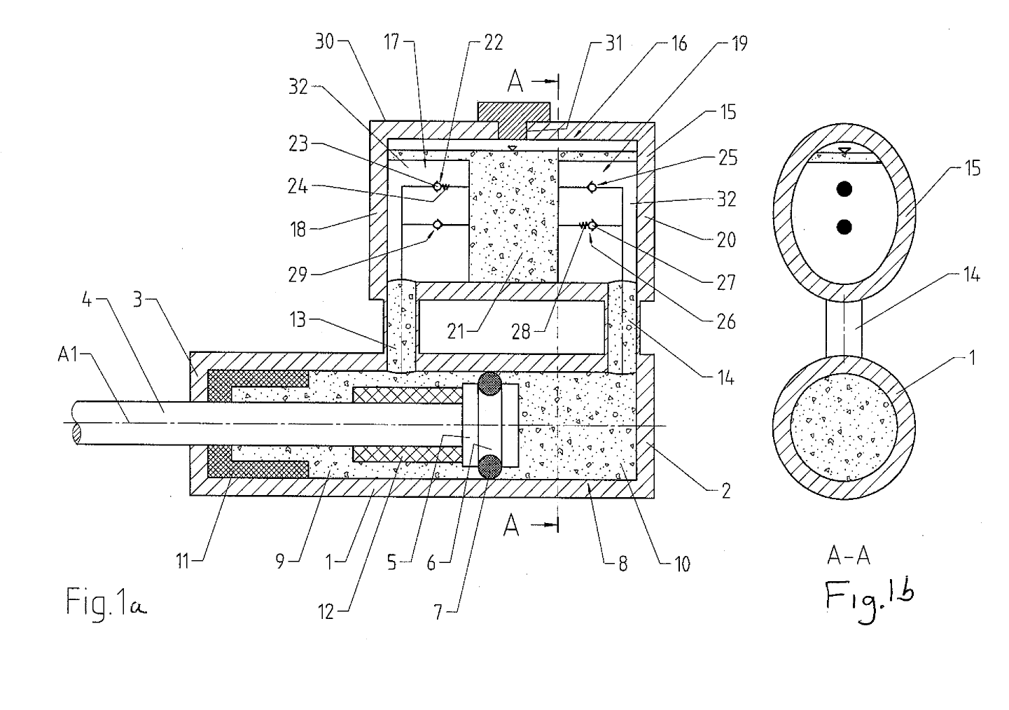

FIGS. 1a and 1b show a continuously blockable locking device, for example, for doors or hatches of motor vehicles. The door arresting device comprises a cylindrical housing 1 with a closed first end 2 and a second end 3 located opposite from the closed end 2. A piston rod 4 arranged coaxial to the center longitudinal axis A₁ is guided out of the housing 1 in a sealed manner through the second end 3 by means of a guiding and sealing device, not shown, such as is constructed, for example, in gas springs or dampers.

A piston 5 which is arranged at the end of the piston rod 4 situated in the housing 1 has a radially circumferential groove 6 with a piston seal 7 located therein. The piston 5 divides the interior of the housing 1, hereinafter designated as work chamber 8, into a first work space 9, through which the piston rod 4 extends, and a second work space 10. However, a possibility for overflow can be provided in the form of one or more axial grooves, not shown, at the inner wall of the work chamber 8 to create an area in which the door arresting device cannot be blocked.

A damping cup 11, shown schematically, is preferably arranged in the first work space 9. A damping sleeve 12 arranged at the piston 5 can penetrate into this damping cup 11 when the piston rod 4 moves outward. The axial length of the damping sleeve 12 is selected in such a way that the piston seal 7 of the piston 5 cannot move over a first connection channel 13 leading out of the housing 1 radially when the damping sleeve 12 strikes the base of the damping cup 11.

The damping device formed by the damping cup 11 and damping sleeve 12 prevents the vehicle door from being moved too quickly against its end stop and possibly swinging back again when the vehicle door is opened to the full extent.

A second connection channel 14 is formed near the first end 2 in the housing 1. The first connection channel 13 and the second connection channel 14 open into the interior of a separate ellipsoidal housing 15 which comprises a valve chamber 16.

A first valve assembly 17 is arranged in the valve chamber 16 near a first end wall 18 of the housing 15 and a second valve assembly 19 is arranged in the valve chamber 16 near a second end wall 20 of the housing 15. The two valve assemblies are arranged at a distance from one another and a connection space 21 is formed between the two valve assemblies.

The first valve assembly 17 comprises a force-loaded check valve 22 whose closing member 23 opens in the direction of flow from the first end wall 18 to the connection space 21 against the force of a helical compression spring 24 when the piston rod 4 moves outward and the pressure in the first work space 9 is accordingly increased. In this way, the fluid displaced by the piston 5 flows into the connection space 21 and then into the second work space 10 via an unloaded check valve 25 of the second valve assembly 19.

In a corresponding manner, the second valve assembly 19 comprises a force-loaded check valve 26 whose closing member 27 opens in the direction of flow from the second end wall 20 to the connection space 21 against the force of a helical compression spring 28 during the inward movement of the piston rod 4 and the resulting increase in pressure in the second work space 10.

The liquid medium displaced by the piston 9 can flow into the connection space 21 and then into the first work space 9 via an unloaded check valve 29 of the first valve assembly 17.

When the piston rod 4 is not loaded, all of the valves are closed and the piston 5 is held in its current position.

The housing 15 can have a closeable opening 31 at its upper side 30 through which the oil and gas can be introduced or removed.

The force-loaded check valves and the unloaded check valves of the first valve assembly 17 and of the second valve assembly 19 are arranged in a material block 32. Material block 32 is preferably part of the housing 15.

The work chamber 8 is preferably always completely filled with a liquid medium, preferably hydraulic oil. The valve chamber 16 is filled with hydraulic oil for the most part and to a small extent with a gas, preferably nitrogen, which is under pressure. The valve chamber 16 can accordingly compensate for variations in the temperature of the oil and the volume of oil displaced by the piston rod when it moves into the work chamber 8. The valve chamber 16 is designed in such a way that the valves are preferably always immersed in oil even when the locking device is sharply inclined.

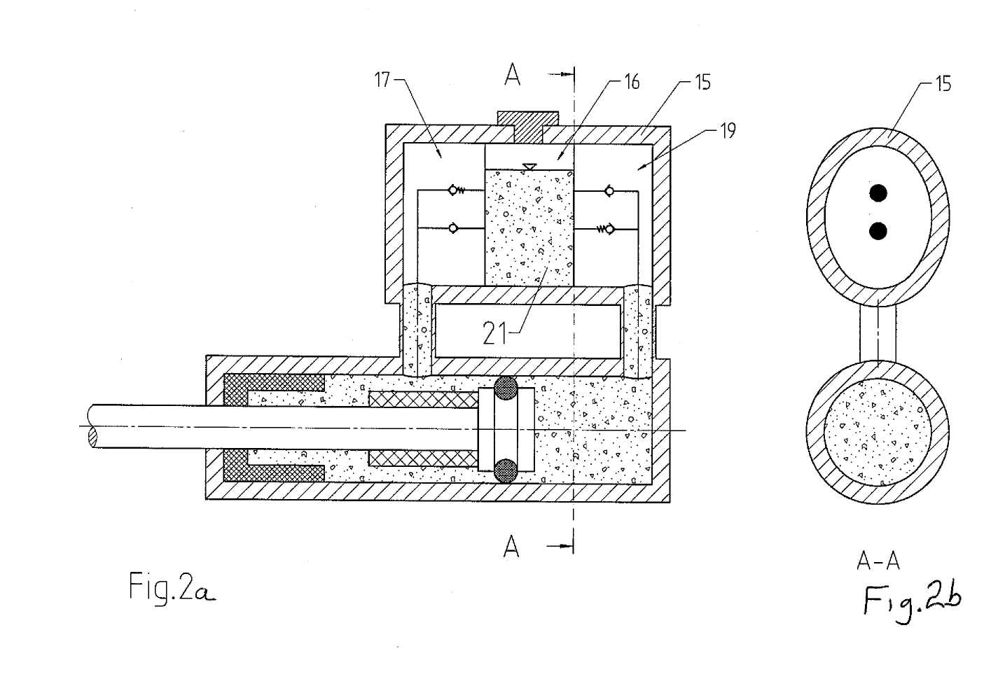

FIGS. 2a and 2b show another embodiment form of the door arresting device according to the invention. The first valve assembly 17 and the second valve assembly 19 completely fill the oval cross section of the valve chamber 16, but again define the connection space 21 which is filled mostly with oil and to a small extent with a gas under pressure, preferably nitrogen. However, in this embodiment form it is also possible to choose a circular cross section for the housing 15 and the valve chamber 16.

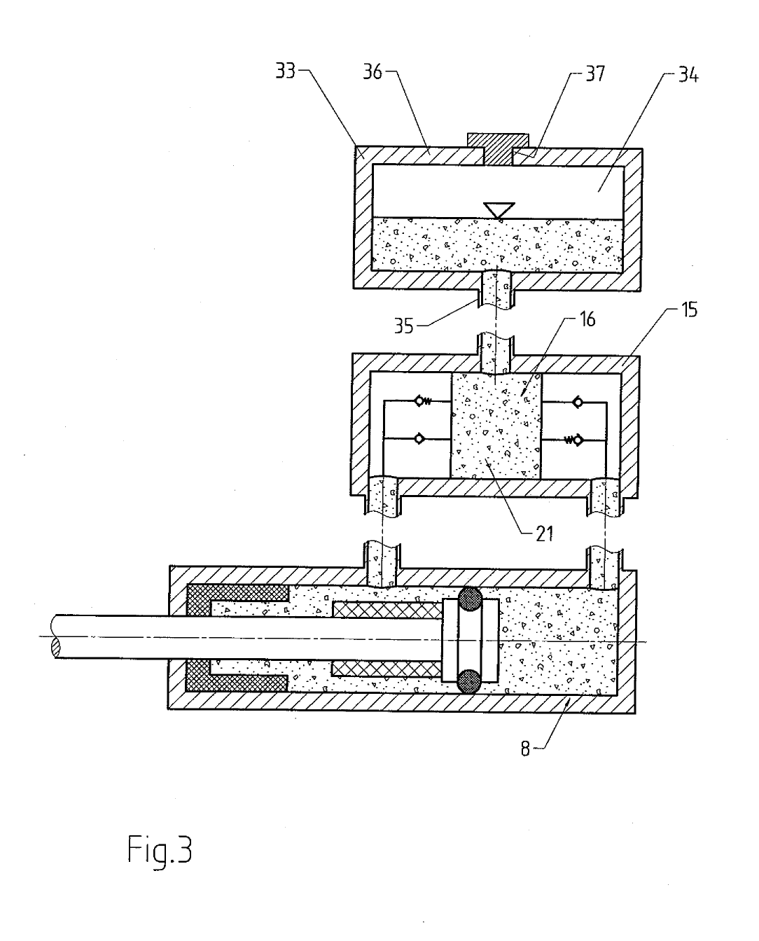

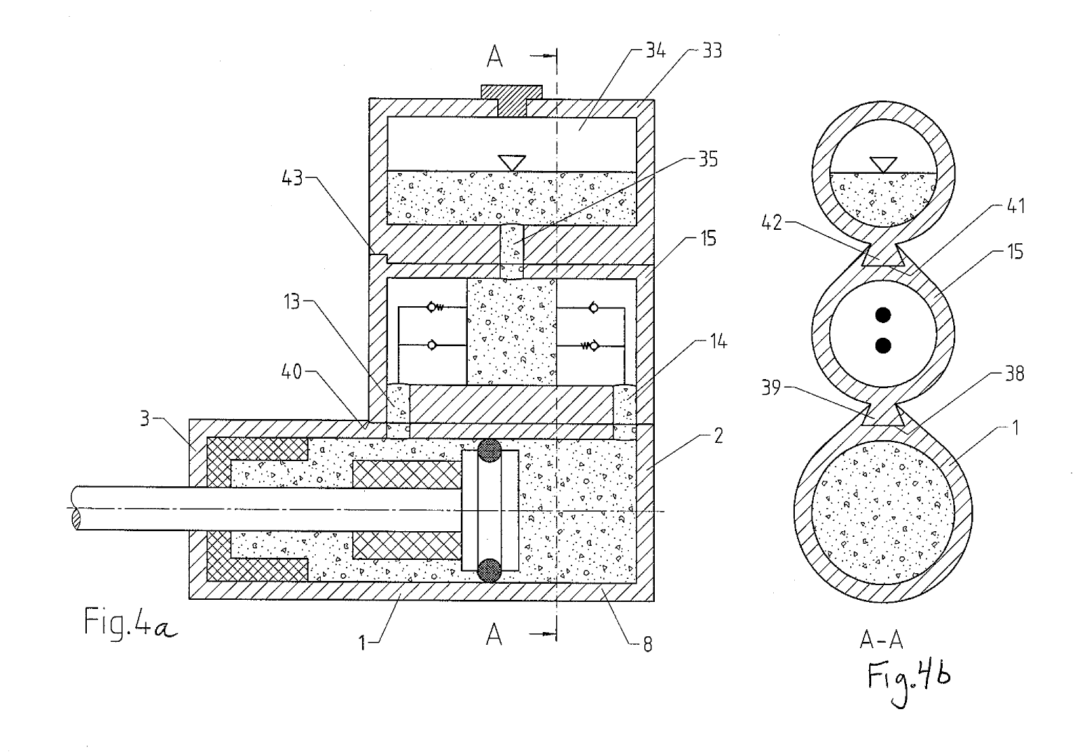

In the embodiment form of the invention shown in FIG. 3, another cylindrical housing 33 whose interior is provided as a volume compensation chamber 34 is arranged parallel to the housing 15. In the area of the connection space 21 which is completely filled with oil in this instance, a third connection channel 35 extends from the valve chamber 16 into the volume compensation chamber 34. The volume compensation chamber 34 is filled with oil and a gas. A closable opening 37 is provided at the upper side 36 of the housing 33 through which the work chamber 8, the valve chamber 16 and the volume compensation chamber 34 can be filled with oil and gas.

FIGS. 4a and 4b show another embodiment form of the invention in which the housings 1, 15 and 33 are connected to one another. A groove 38 having a trapezoidal or dovetail cross section is formed at the side of the housing 1 facing the valve chamber 16. A rail 39 which is also trapezoidal and which is formed at the side of the housing 15 facing the housing 1 can be inserted into the groove 38.

The rail 39 of the housing 15 is inserted into the groove 38 proceeding from the first end 2 of the housing 1 and is displaced in direction of the second end 3 of the housing 1. The length of the groove 38 substantially corresponds to the length of the housing 15. The end 40 of the groove 38 remote of the first end 2 serves as a stop for the rail 39. When the rail 39 is inserted completely, the work chamber 8 and the valve chamber 16 are connected to one another by the first connection channel 13 and the second connection channel 14. The first connection channel and second connection channel are formed in the housings 1 and 15 by openings which are made to overlap.

Further, a groove 41 which also has a trapezoidal or dovetail cross section is formed at the side of the housing 15 facing the volume compensation chamber 34. A rail 42 which is also trapezoidal and which is formed at the side of the housing 33 facing the housing 15 can be inserted into the groove 41. A stop device 43 can be provided at one side of the groove 41 and ensures that the valve chamber 16 is connected to the volume compensation chamber 34 by the third connection channel 35. The third connection channel 35 is formed in the housings 15 and 33 by openings which are made to overlap.

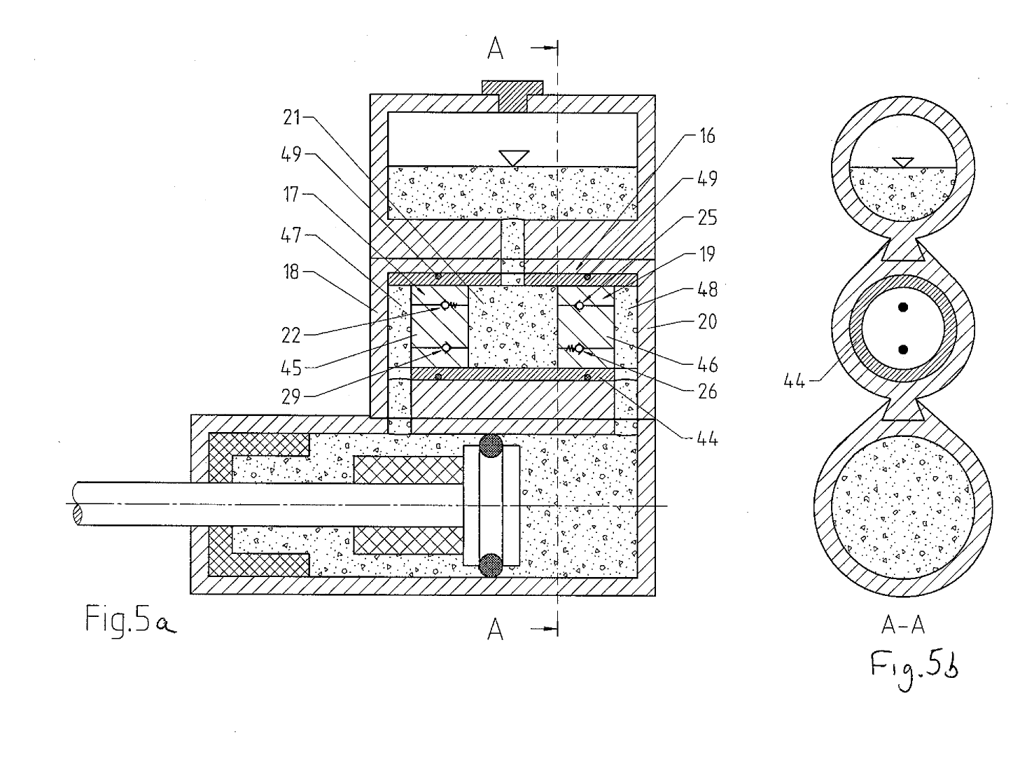

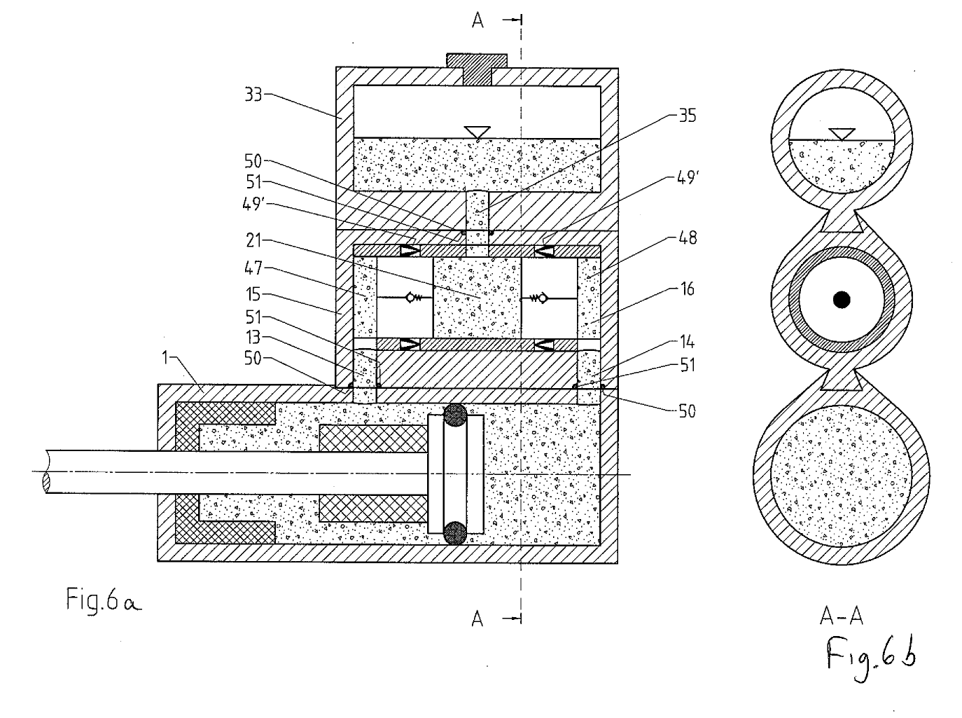

FIGS. 5a and 5b show another embodiment form of the invention in which the two valve assemblies 17 and 19 and their respective force-loaded check valves and unloaded check valves are arranged in a tubular valve receiving body 44 which is located in preassembled state in the valve chamber 16. The valve receiving body 44 has, at its ends, a first closure wall 45 which faces the first end wall 18 and a second closure wall 46 which faces the second end wall 20. A first annular chamber 47 is located between the first end wall 18 and the closure wall 45, and a second annular chamber 48 is located between the second end wall 20 and the closure wall 46. The force-loaded check valve 22 and the unloaded check valve 29 are arranged in the closure wall 45. The force-loaded check valve 26 and the unloaded check valve 25 are arranged in the closure wall 46. The connection space 21 is located between the two closure walls. A sealing device 49 is provided at the ends of the valve receiving body 44 so that the oil can only flow via the valves from the connection space 21 into one of the annular chambers 47, 48, or vice versa.

As is shown in FIGS. 6a and 6b, the unloaded check valves are formed by the two sealing devices 49′. The sealing devices 49′ have a substantially V-shaped cross section or the shape of piston rod seals such as are known, for example, in gas springs or dampers. The V-shaped cross section ensures that the oil can flow from the connection space 21 into the annular chambers 47 or 48 in that the pressure of the oil presses around the sealing lip contacting the inner wall of the valve chamber 16. If the pressure in the annular chambers 47 or 48 increases, the sealing lip is pressed more firmly against the inner wall of the valve chamber 16 and prevents the flow of oil into the connection space 21 through the sealing devices 49′. Further, cutouts 50 are provided at the connection channels 13, 14 and 35, particularly at the housing 15, a sealing element 51 being inserted into these cutouts 50 to achieve a fluid-tight connection. It can be seen that the cutouts 50 and the sealing elements 51 inserted therein can be arranged anywhere at the housings 1, 15 and/or 33. These sealing elements 51 may be omitted in certain cases when the housings are welded together after being joined. Naturally, this also applies to the constructions shown in FIGS. 1 to 5.

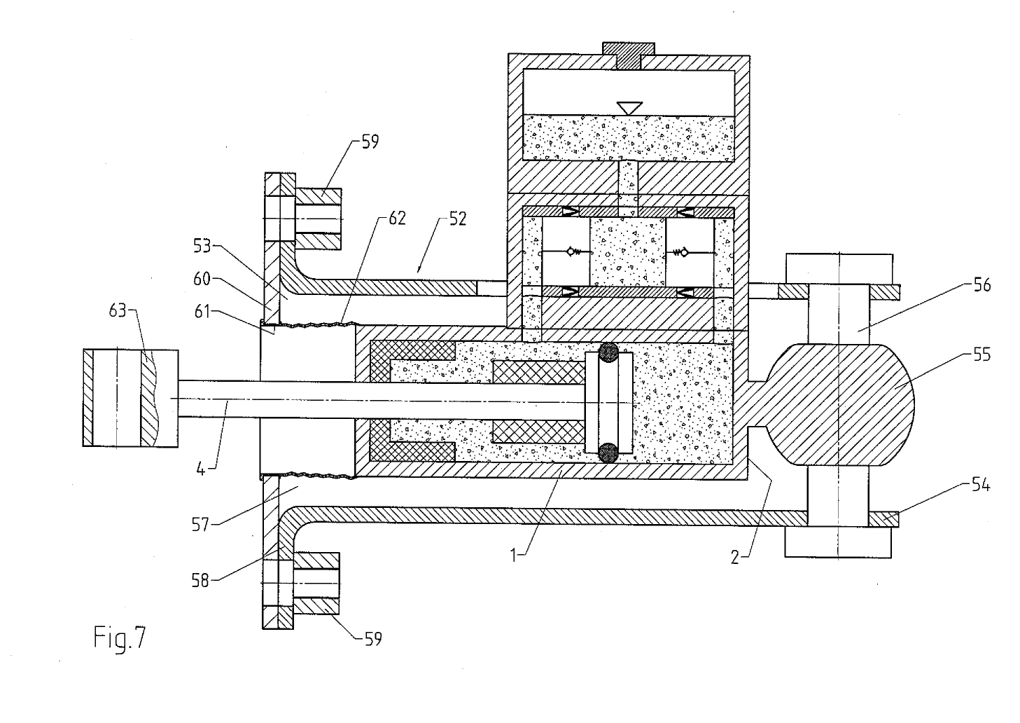

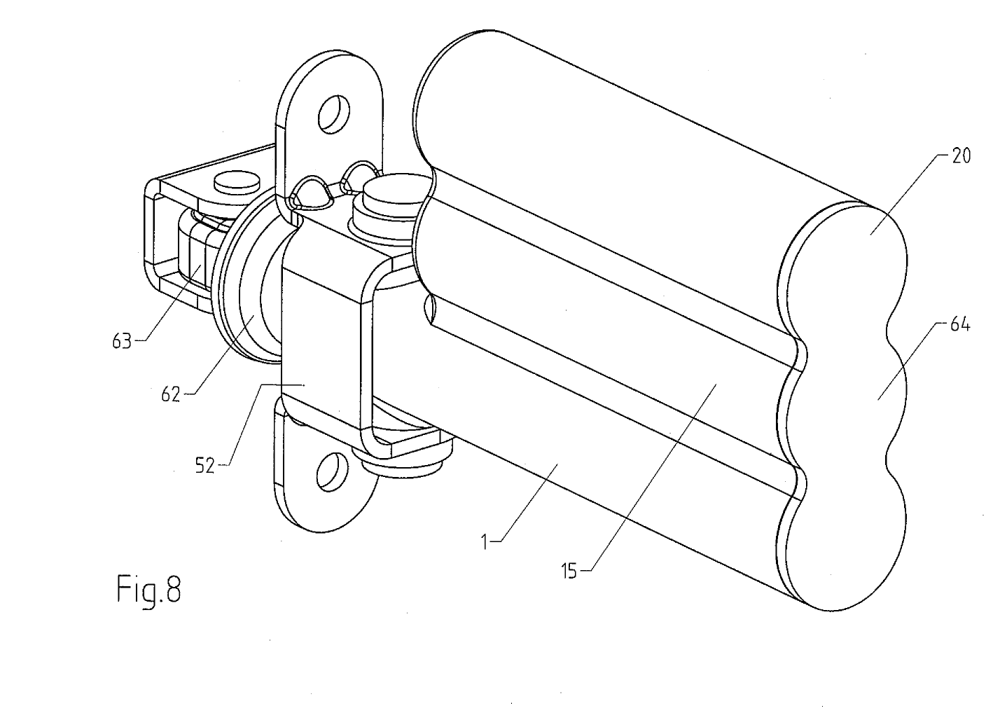

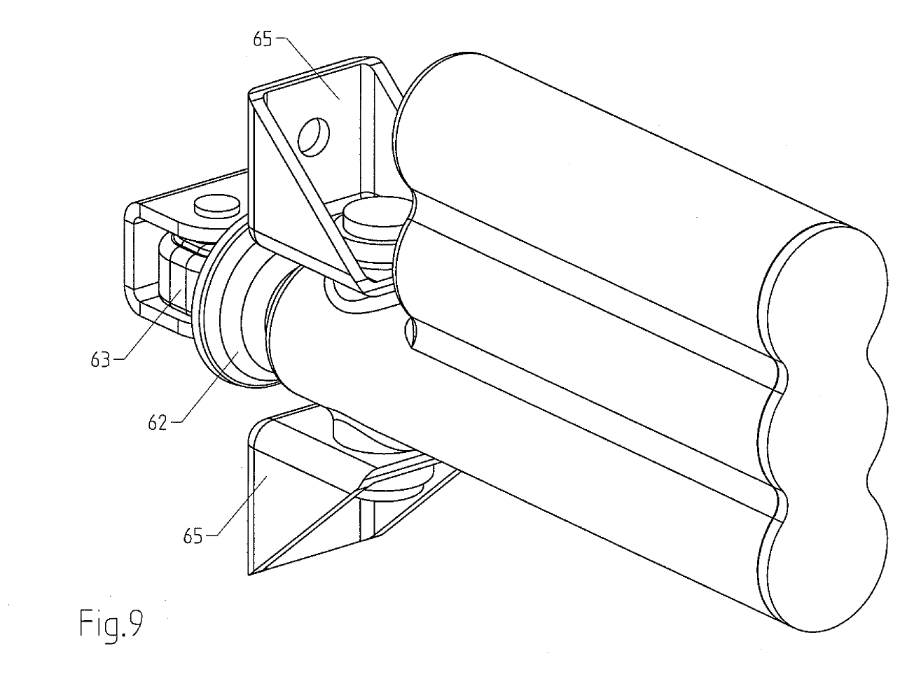

FIG. 7 shows the embodiment example of the door arresting device shown in FIG. 5 with a fastening bracket 52. Of course, other embodiment forms of the locking device can also be provided with a fastening bracket of this kind. The fastening bracket 52 has a substantially U-shaped web 53 whose first end 54 is connected to a knuckle eye 55 arranged at the first end 2 of the housing 1 so as to be swivelable by means of a fastening pin 56. A flange 58 is formed at a second end 57 of the web 53 located opposite from the first end 54. The flange 58 has two projections 59, each having an internal thread by means of which the fastening bracket 52 can be fastened to the vehicle door. The flange is connected to a plate 60 in which is provided a cutout 61 through which the piston rod 4 extends. Bellows 62 is connected to the housing 1 or, as shown in FIGS. 8 and 9, to the piston rod 4 near a connection element 63 can be inserted into the cutout 61.

In the embodiment form of the invention shown in FIG. 8, the fastening bracket 52 is fastened to the housing 1 at an area extending past the housing 15 of the valve chamber 16. The axial extension of the fastening bracket 52 is also substantially limited to this area. Further, it can be seen that the second end wall 20 of the housing 15 can also be formed by a cover 64 which is welded or glued to the housing parts and also closes housing 1 and housing 33.

In the embodiment form shown in FIG. 9, the door arresting device is fastened by means of two angled plates 65 which are fastened to the area of the housing 1 of the work chamber 8 extending past the housing 16 of the valve chamber 16.

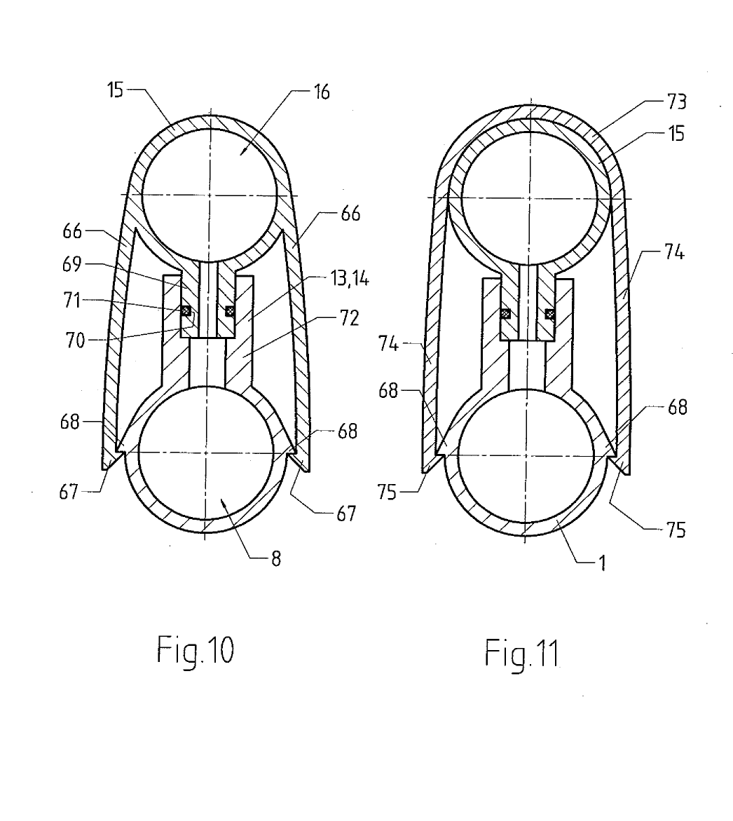

FIG. 10 shows another embodiment of the invention. At least two catch arms 66 extend from the housing 15 of the valve chamber 16, each catch arm 66 having a hook 67. The hooks 67 engage in such a way behind a catch projection 68 formed laterally at the housing 1 that the first and second connection channels 13, 14, respectively, connect the work chamber 8 and the valve chamber 16 or housing 1 and housing 15 to one another. The connection channel 13 and 14, respectively, are formed by a tubular extension 69 which extends radially from the housing 15 and which has a radially circumferential groove 70 in which a sealing ring 71 is inserted and by a tubular extension 72 which extends radially from the housing 1 and which is slid over the extension 69. The sealing ring 71 ensures that a fluid-tight connection is provided.

As is shown in FIG. 11, the housing 1 and the housing 15 are held together by a clamp 73 comprising two catch arms 74, each of which again has a hook 75 which engages behind the catch projections 68 formed laterally at the housing 1.

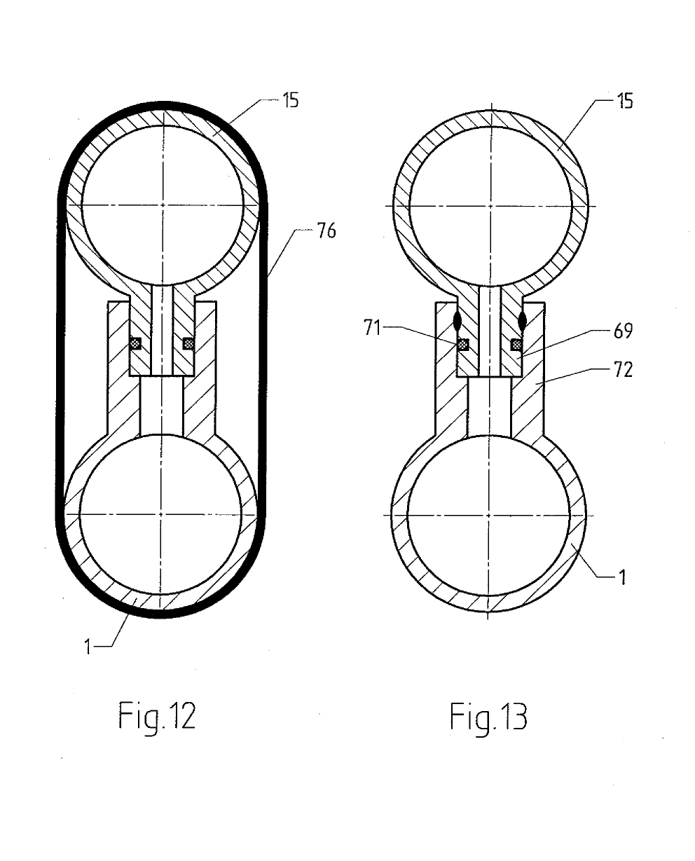

In an embodiment shown in FIG. 12, the housing 1 and the housing 15 are surrounded by a belt-like holding element 76 which holds together the two housings 1, 15.

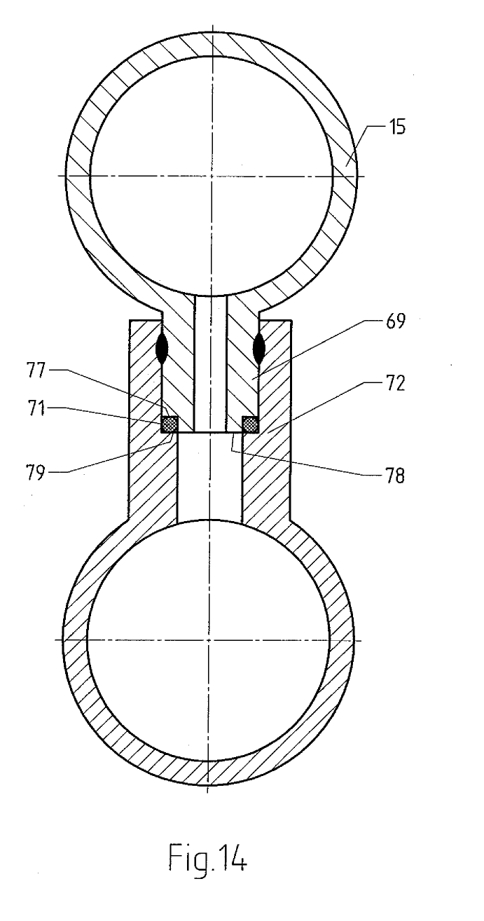

FIG. 13 shows another embodiment for connecting the two housings 1 and 15. After the two radial extensions 69, 72 have been joined together, they are welded together at least in some areas, for example, by a laser welding method or ultrasonic welding method. The weld need not necessarily be tight against fluid because that function is performed by the sealing ring 71.

In the embodiment shown in FIG. 14, the sealing ring 71 is arranged in a step 77 at the end 78 of the extension 69 and, further, contacts a step 79 in the extension 72. This step 77 can be produced in a simple manner.

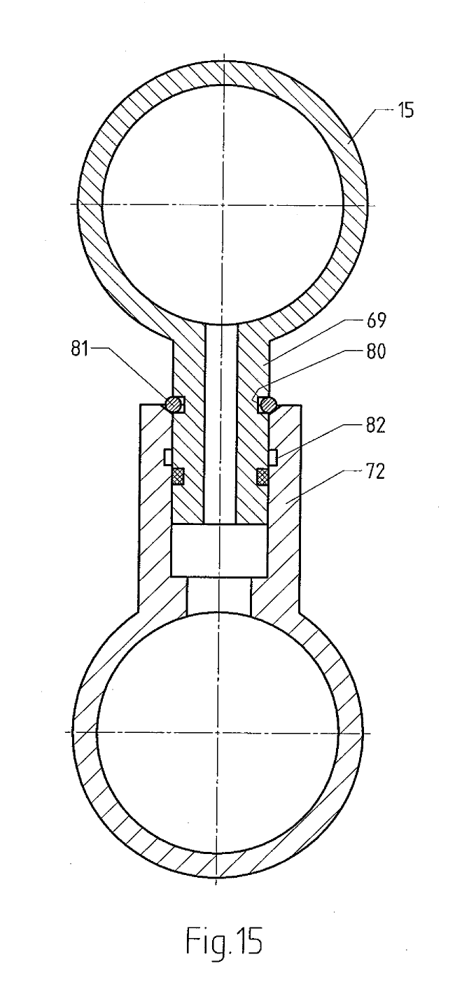

In the embodiment shown in FIG. 15, the extension 69 formed at the housing 15 has another groove 80 in which a snap ring 81 is inserted which is completely pressed into the groove 80 when joining together and which snaps into the groove 82 which is formed inside the extension 72 when a defined position is reached. The side walls of the groove 82 have a smaller radial extension than the diameter of the snap ring.

It can be seen that in all of the variants shown in FIGS. 10 to 15 the end 78 of extension 69 and/or the end 78 of extension 72 can serve as a stop to define the distance between the two housings 1 and 15. It can also be seen that the same principal can be applied to connect the housings 15 and 33 or housings 1, 15 and 33.

The door arresting devices shown in the drawings are preferably made of plastic but can also be made of, e.g., aluminum, steel or an alloy of a wide variety of metals, which makes it possible to achieve a reduction in weight. Further, the individual housings can comprise two halves which are connected to one another or can comprise a main body which is closed by at least one cover 62. Further, the constructions described above, for example, with respect to the valve assembles 17, 19, the fastening bracket 52, or the like, can, of course, also apply to the embodiment forms described in the following.

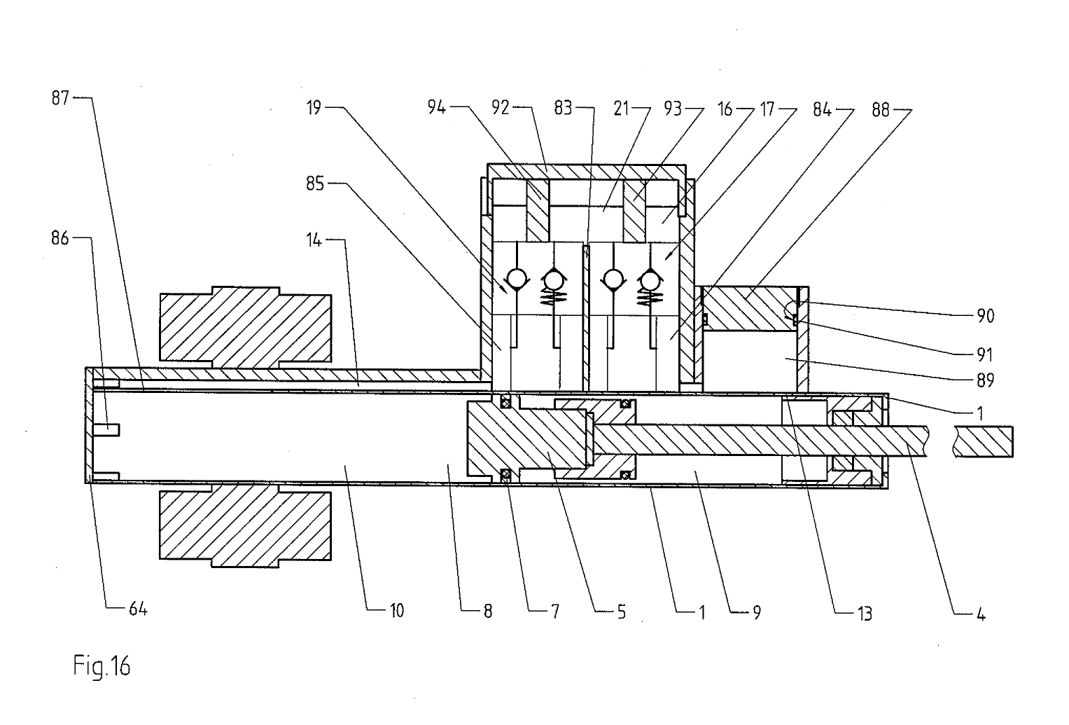

In the embodiments shown in FIGS. 16 to 19, first and second valve assembles 17, 19 are not constructed in a common center axis; rather, they are parallel to one another but perpendicular to the cylindrical work chamber 8. The connection space 21 which directly connects the first and second valve assemblies 17, 19 to one another adjoins the end of the upwardly directed side of the two valve assemblies which is remote of the work chamber 8. The connection space 21 is partly filled with gas to compensate for the volume displaced by the inward and outward movement of the piston rod 4 of the door adjustment system and for the thermal expansion of the liquid work medium.

In order to realize a compact construction with valve assemblies 17 and 19 arranged closely adjacent to one another for both directions, the valve chamber 16 is divided at least partially into a first partial chamber 84 and a second partial chamber 85 by means of a dividing wall 83. The first valve assembly 17 is accommodated in the first partial chamber 84, and the second valve assembly 19 is accommodated in the second partial chamber 85. The two partial chambers 84, 85 are connected to one another by the connection space 21. Further, a flow guide is provided which provides the connection channel 14 parallel to the work chamber 8 and forms a fluidic connection between the second work space 10 and the second partial chamber 85 of the valve chamber 16 and, therefore, with the second valve assembly 19. The advantage of this embodiment form consists in that any length of the work chamber 8 and, consequently, any lift length can be provided regardless of the structural size of the valve chamber 16. In addition, flow channels 86 can also be provided in the cover 64 closing the work chamber 8. In a suitable embodiment form, a connection slot 87 can be used between the second work space 10 and the second connection channel 14 which is guided parallel to the latter so that there is a flow around the piston seal 7 of the piston 5 and, in this way, an area is provided which is free of locking forces.

The first connection channel 13 connects the first work space 9 to the first partial chamber 84 of the valve chamber 16 by a receiving chamber 89 which is closed by a cover 88. As is shown in the drawing, the cover 88 can be provided with an annular groove 90 into which a sealing ring 91 is inserted to seal the receiving chamber 89 from the outer environment.

A cover 92 is likewise arranged on the valve chamber 16 and closes the valve chamber 16 so as to seal it from the outer environment. Further, the cover 92 serves to hold the first valve assembly 17 and second valve assembly 19 in their position. For this purpose, the cover 92 has, for every valve assembly, a holding web 93 and 94, respectively, around which work medium flows and which brings the valve assemblies into contact with the wall of the work chamber 8.

It should be noted that the receiving chamber 89 and the valve chamber 16 are constructed closer to the second end 3 of the housing 1.

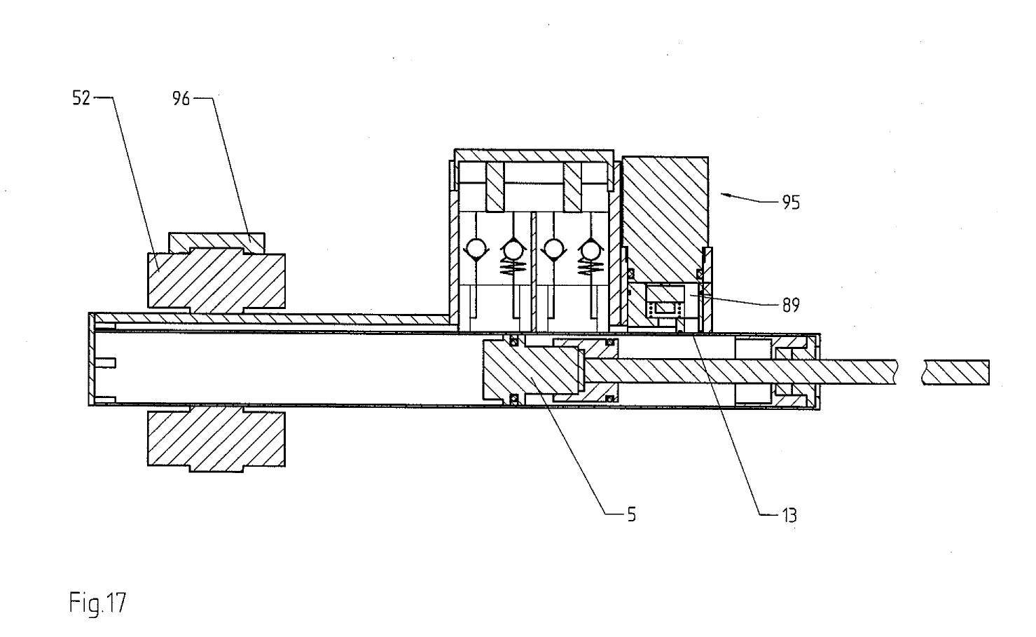

As can be seen from FIG. 17, the cover 88 from FIG. 16 can be omitted and an electrically controllable valve unit 95, shown schematically, can be arranged in place of the cover 88 at the receiving chamber 89. In addition, a sensor device 96 is arranged at the pivot point of the housing 1 at the fastening bracket 52 which is shown schematically. The angle and/or angular velocity can be determined by means of this sensor device 96. In cooperation with a device, not shown, for detecting obstacles, for example, a camera, a capacitive sensor, or the like, the valve unit 95, which is preferably constructed as a proportional valve, can close the first connection channel 13, preferably to an increasing extent as the door approaches the obstacle. However, it is also possible that the valve can be closed abruptly. By closing the connection channel 13, the flow of medium is blocked in the entire system and the piston 5 is accordingly rigidly locked. The door cannot be moved any farther.

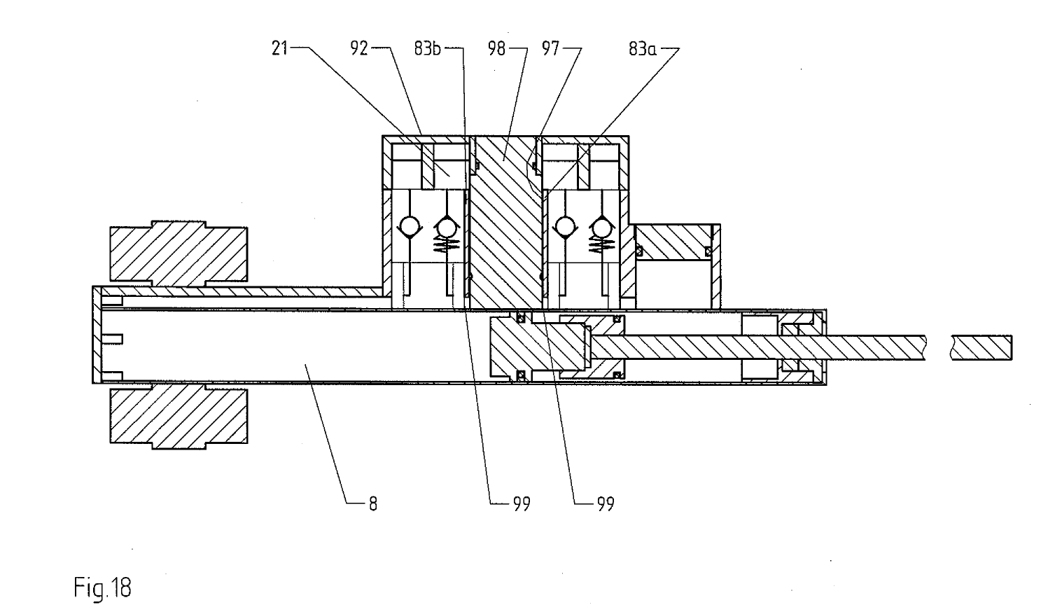

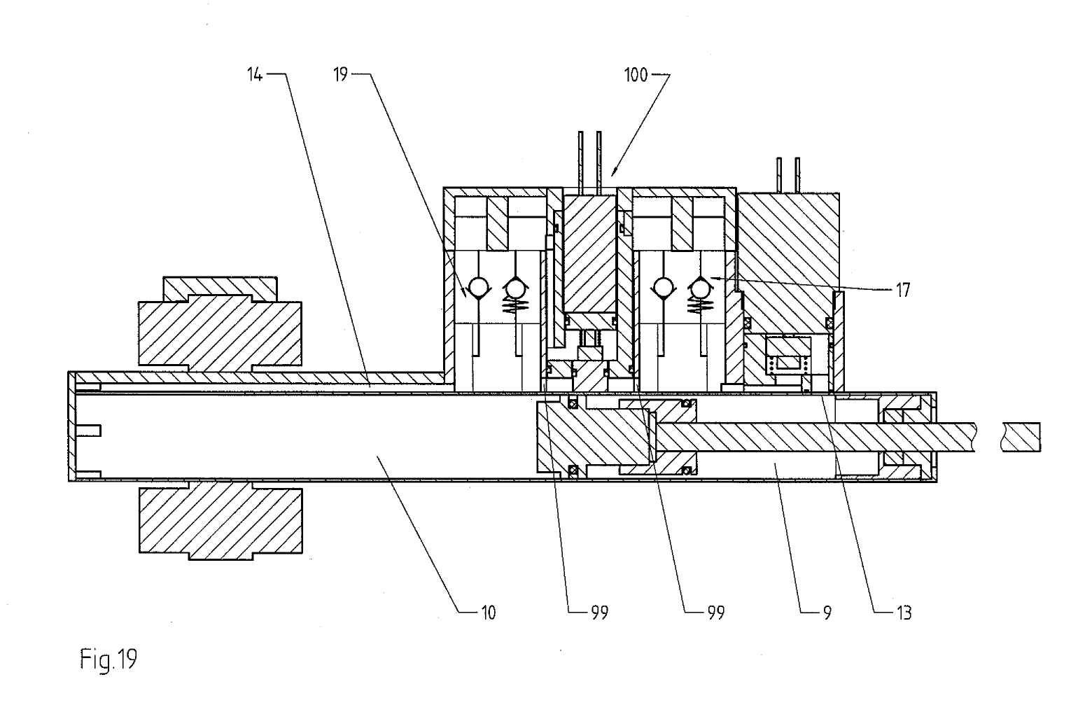

The embodiment shown in FIG. 18 substantially corresponds to the locking device shown in FIG. 16, but the dividing wall 83 in the valve chamber 16 is formed by two dividing walls 83a and 83b which form a receiving space 97 therebetween in which a cylindrical filling body 98 is arranged. Near the work chamber 8, the dividing walls 83a and 83b have openings 99 which open into the receiving space 97, but which are closed by the filling body 98 so as to be tight against fluid. The working medium flows around the part of the filling body 98 that is close to the cover 92, that is, the part of the filling body 98 located in the connection space 21. In other respects, the operation of the locking device corresponds exactly to that of the embodiment form shown in FIG. 16.

FIG. 19 shows the door arresting device from FIG. 18 in which the filling body 98 from FIG. 18 has been replaced by another electrically controllable valve unit 100 which is also shown schematically. By means of the valve unit 100, the first valve assembly 17 and the second valve assembly 19 can be short-circuited by releasing the openings 99, and the work medium can flow directly through the connection channels 13 and 14 from one of the work spaces 9 or 10 into the other work space. Accordingly, the medium no longer flows through the valve assemblies 17 and 19 because of their high flow resistance which comprises the blocking force of the entire system. In this way, the door can be moved very easily in the closing direction and in the opening direction. The valve of the valve unit 100 can preferably be opened when, for example, a user's hand is sensed at a door handle, not shown.

It is clear from the embodiment forms shown in FIGS. 16 to 19 that various functions can also be provided subsequently when the locking device is already installed, namely, in addition to the simple locking function, an obstacle function can be provided through the installation of the valve unit 95 and a convenience function can be provided through the installation of the valve unit 100, or both additional functions can be provided at the same time.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A continuously blockable locking device comprising:
a cylindrical first housing forming a work chamber completely filled with a liquid medium, the cylindrical first housing having a closed first end and a second end located opposite the closed end;
a piston rod arranged coaxial to a center longitudinal axis of the cylindrical first housing, the piston rod being guided out of the second end of the cylindrical first housing in a sealed manner;
a piston arranged at an end of the piston rod situated in the cylindrical first housing, the piston divides the work chamber into a first work space, through which the piston rod extends and a second work space;
a second housing configured to be connected to the cylindrical first housing, the second housing forming a valve chamber that is at least partially filled with a liquid medium;
a first valve assembly arranged in the valve chamber; and
a second valve assembly arranged in the valve chamber.

2. The continuously blockable locking device according to claim 1, further comprising:
a first connection channel constructed proximate to a first end wall of the valve chamber; and
a second connection channel constructed proximate to a second end wall of the valve chamber,
wherein the first connection channel and the second connection channel are configured to couple the work chamber to the valve chamber.

3. The continuously blockable locking device according to claim 1, wherein the valve chamber is partially filled with a gas under pressure.

4. The continuously blockable locking device according to claim 3, wherein the liquid medium is a hydraulic oil and the gas is nitrogen.

5. The continuously blockable locking device according to claim 2, wherein the first valve assembly is arranged in the valve chamber proximate to the first end wall and the second valve assembly is arranged in the valve chamber proximate to the second end wall.

6. The continuously blockable locking device according to claim 5, wherein the first and second valve assemblies are arranged at a distance from one another and a connection space is formed between the two valve assemblies.

7. The continuously blockable locking device according to claim 6, wherein the first valve assembly comprises a first force-loaded check valve having a closing member, the closing member opens in a direction of flow from the first end wall to the connection space against a force of a helical compression spring during an outward movement of the piston rod and resulting increase in pressure in the first work space, wherein the liquid medium displaced by the piston flows into the connection space and then into the second work space via an unloaded check valve of the second valve assembly.

8. The continuously blockable locking device according to claim 7, wherein the second valve assembly comprises a second force-loaded check valve having a closing member, the closing member opens in a direction of flow from the second end wall to the connection space against the force of a helical compression spring during an inward movement of the piston rod and the resulting increase in pressure in the second work space, wherein the liquid medium displaced by the piston flows into the connection space and then into the first work space via an unloaded check valve of the first valve assembly.

9. The continuously blockable locking device according to claim 1, wherein the second housing has a closable opening through which the liquid medium and gas can be introduced or removed.

10. The continuously blockable locking device according to claim 8, wherein the force-loaded check valves and the unloaded check valves of the first valve assembly and of the second valve assembly are arranged in a material block, wherein the material block is part of the second housing.

11. The continuously blockable locking device according to claim 1, wherein the valve chamber comprises one of a circular or partially oval cross-sectional shape.

12. The continuously blockable locking device according to claim 1, wherein the work chamber has a longer extension in an axial direction than the valve chamber.

13. The continuously blockable locking device according to claim 12, further comprising:
a damping cup arranged proximate to the second end of the cylindrical first housing; and
a damping sleeve arranged at the piston configured to penetrate into the damping cup when the piston rod moves outward.

14. The continuously blockable locking device according to claim 1, further comprising:
a third housing comprising a volume compensation chamber, the volume compensation chamber filled with the liquid medium and a gas; and
a third connection channel extending from the connection space configured to connect the second housing to the third housing.

15. The continuously blockable locking device according to claim 14, wherein the third housing of the volume compensation chamber comprises a closable opening through which the liquid medium or the gas can be introduced or removed.

16. The continuously blockable locking device according to claim 8, wherein the first and second valve assemblies and their respective force-loaded and unloaded check valves are arranged in a tubular valve receiving body configured to be inserted into the valve chamber.

17. The continuously blockable locking device according to claim 16, wherein the valve receiving body comprises:
a first closure wall that faces the first end wall;
a second closure wall that faces the second end wall;
a first annular chamber located between the first end wall and the first closure wall; and
a second annular chamber located between the second end wall and the second closure wall.

18. The continuously blockable locking device according to claim 17, wherein the force-loaded check valve and the unloaded check valve of the first valve assembly are arranged in the closure first wall, and the force-loaded check valve and the unloaded check valve of the second valve assembly are arranged in the second closure wall.

19. The continuously blockable locking device according to claim 18, further comprising a sealing device at each the respective ends of the valve receiving body.

20. The continuously blockable locking device according to claim 19, wherein the respective sealing devices form the unloaded check valves.

21. The continuously blockable locking device according to claim 1, wherein the second housing is arranged at a fastening bracket.

22. The continuously blockable locking device according to claim 21, wherein the fastening bracket is a substantially-U-shaped web having a first end connected by a fastening pin to a knuckle eye arranged at the first end of the cylindrical first housing.

23. The continuously blockable locking device according to claim 22, wherein a flange is formed at a second end of the web located opposite the first end, the flange having at least one projection, each the at least one projection having an internal thread configured to fasten the bracket to a swivelable structural component part.

24. The continuously blockable locking device according to claim 23, wherein the flange is connected to a plate having a cutout through which the piston rod extends, wherein a bellows is connected to the piston rod proximate to a connection element or the cylindrical first housing, the connection element formed as a ball socket configured to be inserted into the cutout.

25. The continuously blockable locking device according to claim 24, wherein the fastening bracket is arranged at the area of the cylindrical first housing extending beyond the housing of the valve chamber.

26. The continuously blockable locking device according to claim 25, wherein the cylindrical first housing is fastened by two angled plates to the area of the cylindrical first housing of the work chamber extending beyond the second housing of the valve chamber.

27. The continuously blockable locking device according to claim 2, wherein the first and second connection channels are configure as:
at least one tubular extension that extends radially from the second housing, the at least one tubular extension having a radially circumferential groove in which a sealing ring is inserted; and
at least one tubular extension that extends radially from the cylindrical first housing and configured to slideably mate with the at least one extension that extends from the second housing.

28. The continuously blockable locking device according to claim 27, wherein at least two catch arms extend from the second housing of the valve chamber, each catch arm comprising a hook configured to engage corresponding catch projections formed at the cylindrical first housing, wherein the first connection channel and second connection channel connect the work chamber and the valve chamber and the cylindrical first housing and the second housing are connected to one another.

29. The continuously blockable locking device according to claim 27, wherein the cylindrical first housing and the second housing are held together by a clamp comprising two catch arms, each catch arm comprising a hook configured to engage corresponding catch projections formed at the second housing.

30. The continuously blockable locking device according to claim 27, wherein the cylindrical first housing and the second housing are surrounded by a belt-like holding element that holds together the first and second housings together.

31. The continuously blockable locking device according to claim 27, wherein the two radial extensions are welded together in at least one area.

32. The continuously blockable locking device according to claim 27, wherein the tubular extension formed at the second housing has another groove configured to accept a snap ring completely pressed into the groove, the snap ring further configured to snaps into a groove formed inside the tubular extension of the cylindrical first housing when a defined position is reached.

33. The continuously blockable locking device according to one of claims 1, wherein first and second valve assemblies are arranged parallel to one another and perpendicular to the cylindrical work chamber.

34. The continuously blockable locking device according to claim 33, wherein the connection space that connects the first and second valve assemblies to one another adjoins the respective ends of the two valve assemblies that are remote from the work chamber.

35. The continuously blockable locking device according to claim 33, wherein the valve chamber divided into a first partial chamber and a second partial chamber by a dividing wall, the first valve assembly being accommodated in the first partial chamber and the second valve assembly being accommodated in the second partial chamber, and the two partial chambers being connected to one another by the connection space.

36. The continuously blockable locking device according to claim 33, wherein the second connection channel is formed parallel to the work chamber and forms a fluidic connection between the second work space and the second valve assembly.

37. The continuously blockable locking device according to claim 36, further comprising at least one of:
a flow channel in a cover configured to close the work chamber; and
a connection provided between the second work space and the second connection channel.

38. The continuously blockable locking device according to claim 33, wherein the first connection channel connects the first work space to the valve chamber by a receiving chamber.

39. The continuously blockable locking device according to claim 33, wherein a cover is arranged on the valve chamber, the cover closes the valve chamber to seal it relative to an outer environment, the cover further configured to hold the first valve assembly and second valve assembly in their respective positions, wherein the cover has a respective holding web for each valve assembly around which the liquid medium flows and which brings the valve assemblies into contact with the wall of the work chamber.

40. The continuously blockable locking device according to claim 38, wherein at least one of an electrically controllable valve unit and a cover are arranged at the receiving chamber.

41. The continuously blockable locking device according to claim 33, wherein a sensor device is arranged at the pivot point of the cylindrical first housing at the fastening bracket, the sensor device configured for the determination of at least one of an angle and angular velocity.

42. The continuously blockable locking device according to claim 33, wherein the dividing wall in the valve chamber is formed by two dividing walls forming a receiving space therebetween.

43. The continuously blockable locking device according to claim 42, wherein an electrically controllable valve unit or a filling body is inserted into the receiving space, wherein the filling body keeps two openings the dividing walls closed, and the openings are configured to be opened or closed by the valve unit.

44. The continuously blockable locking device according to claim 1, wherein the cylindrical first housing is coupled to the second housing by a rail on one of the cylindrical first housing and the second housing and a groove on the other of the cylindrical first housing and the second housing, the rail configured to mate with the groove.

45. The continuously blockable locking device according to claim 44, wherein the rail is substantially trapezoidal in cross section.
